(19) United States
(12) Patent Application Publication
(10) Pub. No.: US 2011/0128639 A1
(43) Pub. Date: Jun. 2, 2011

(54) OPTICAL PICKUP DEVICE

(75) Inventors: Takanari HONDA, Yokohama-shi (JP); Tadashi TOUYAMA, Yokohama-shi (JP)

(73) Assignee: VICTOR COMPANY OF JAPAN, LIMITED, Yokohama-shi (JP)

(21) Appl. No.: 12/955,339

(22) Filed: Nov. 29, 2010

(30) Foreign Application Priority Data
Nov. 30, 2009 (JP) 2009-271973
Jun. 10, 2010 (JP) 2010-226417

(51) Int. Cl. G02B 7/02

(52) U.S. Cl. 359/819

(57) ABSTRACT

Provided is an optical pickup device that may efficiently reduce an inclination of an objective lens caused by change in ambient temperature. A lens holder holds the object lens and includes a receiving surface portion contacts a lower surface portion of a periphery portion of an objective lens, and a plurality of protrusions that protrude from the receiving surface portion to contact a peripheral side surface portion of the objective lens and are separated from each other. In a state where the objective lens is held on the lens holder, an adhesive is applied to span over a part of the peripheral side surface portion that does not face the protrusions, and a part of the receiving surface portion that does not contact the lower surface portion of a periphery portion of the objective lens, thus the objective lens is fixed on the lens holder by the adhesive.

### CROSS-REFERENCE TO RELATED PATENT APPLICATIONS

This application claims the benefit of Japanese Patent Application No. 2009-271973, filed on Nov. 30, 2009 and Japanese Patent Application No. 2010-226417, filed on Oct. 6, 2010, in the Japan Patent Office, the disclosure of which is incorporated herein in its entirety by reference.

### BACKGROUND OF THE INVENTION

1. Field of the Invention

The present invention relates to an optical pickup device used in an optical disk apparatus for reproducing data recorded in an optical disk such as a CD or a DVD, or for recording data in the optical disk.

2. Description of the Related Art

An optical pickup device includes an objective lens and a lens holder on which the objective lens is placed. The objective lens is fixed on the lens holder by an adhesive. When the objective lens is fixed on the lens holder, the adhesive may move onto a lower surface of a periphery portion of the objective lens. If the objective lens is fixed on the lens holder in a state where the adhesive is moved onto the lower surface of the periphery portion of the objective lens, the adhesive may expand or contract according to temperature change, and thus, the objective lens may be inclined with respect to the lens holder. When the objective lens is inclined with respect to the lens holder, optical characteristics of the optical pickup device deteriorate. Thus, there have been many suggestions for preventing the adhesive from moving onto the lower surface of the periphery portion of the objective lens.

Patent Document 1 discloses that a recess portion for collecting a remaining adhesive is formed on a surface of the lens holder, on which the lower surface of the periphery portion of the objective lens is placed. Patent Document 2 discloses that the lens holder includes a lens mount portion for receiving a side surface and a lower surface of the periphery portion of the objective lens, and an adhesive applying portion on which adhesive is applied, separated from each other. Patent Document 3 discloses that the objective lens is firmly attached to the lens holder by spreading the adhesive applied between an upper edge surface of the lens holder and the side surface of the periphery portion of the objective lens over the entire periphery portion of the objective lens.

(Patent Document 1) Japanese Laid-open Patent Publication No. hei 8-329508

(Patent Document 2) Japanese Laid-open Patent Publication No. 2007-184060

(Patent Document 3) Japanese Laid-open Patent Publication No. 2000-215489 (paragraph 0031 and FIG. 4)

Even in the above described conventional optical pickup device, after fixing the objective lens on the lens holder by using the adhesive, the objective lens may be inclined with respect to the lens holder due to a change in ambient temperature, thereby degrading optical characteristics of the optical pickup device. Thus, a problem of the objective lens inclining due to a temperature characteristic of the adhesive is not addressed yet.

### SUMMARY OF THE INVENTION

The present invention provides an optical pickup device that may efficiently reduce inclination of an objective lens due to a change in ambient temperature.

According to an aspect of the present invention, there is provided an optical pickup device including: an objective lens; and a lens holder holding the objective lens and including a receiving surface portion contacts a lower surface portion of a periphery portion of the objective lens, and a plurality of protrusions that protrude from the receiving surface portion to contact a peripheral side surface portion of the objective lens and are separated from each other, wherein, in a state where the objective lens is held on the lens holder, an adhesive is applied to span over a part of the peripheral side surface portion that does not face the protrusions and a part of the receiving surface portion that does not contact the lower surface portion of a periphery portion of the objective lens, thus the objective lens is fixed on the lens holder by an adhesive.

In this configuration, the adhesive may not be applied between the peripheral side surface portion of the objective lens and the protrusions.

In this configuration, an angle range of portion in which none of the protrusions are formed may be greater than an angle range of portion in which each of the protrusions is formed, in a circumferential direction of the objective lens on the receiving surface portion.

### BRIEF DESCRIPTION OF THE DRAWINGS

The above and other features and advantages of the present invention will become more apparent by describing in detail exemplary embodiments thereof with reference to the attached drawings in which:

FIG. 1 is a plan view of principal parts in an optical pickup device according to an embodiment of the present invention;

FIG. 2 is a cross-sectional view of the optical pickup device taken along a line A-A of FIG. 1;

FIG. 3 is a cut perspective view of the optical pickup device taken along a line B-B of FIG. 1;

FIG. 4 is a perspective view illustrating an objective lens being inserted into a lens holder, during fabrication of the optical pickup device of FIG. 1;

FIG. 5 is a perspective view illustrating fixing of the objective lens inserted in the lens holder to the lens holder by an adhesive, during the fabrication of the optical pickup device of FIG. 1; and

FIG. 6 is an upper plan view showing a range in which protrusions exist in the optical pickup device of FIG. 1.

### DETAILED DESCRIPTION OF THE INVENTION

The attached drawings for illustrating exemplary embodiments of the present invention are referred to in order to gain a sufficient understanding of the present invention, the merits thereof, and the objectives accomplished by the implementation of the present invention.

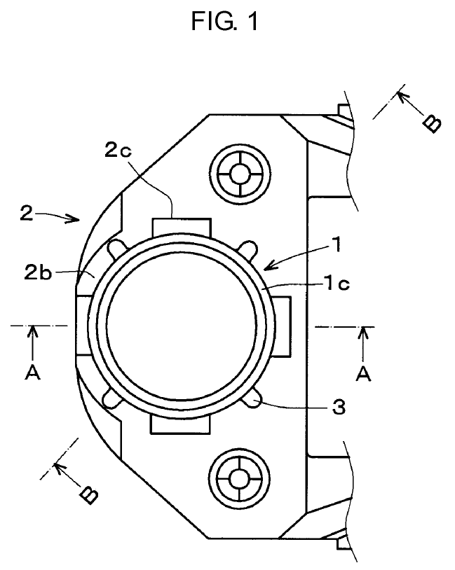

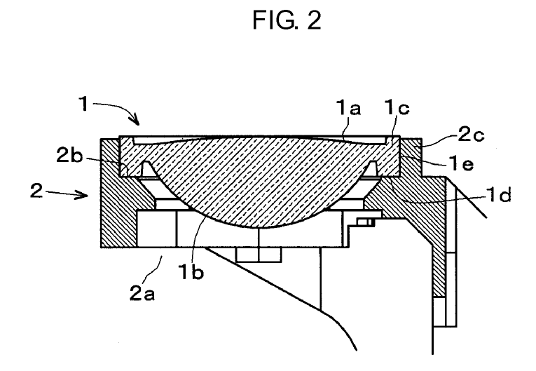

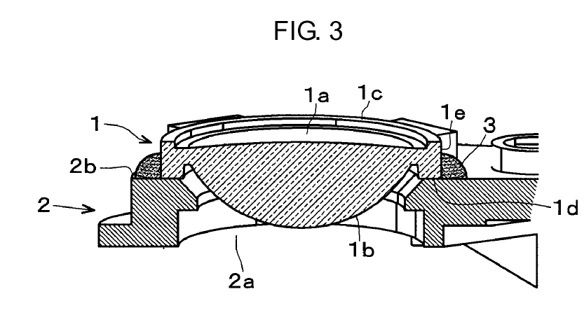

Hereinafter, the optical pickup device of the present invention will be described in detail by explaining exemplary embodiments of the invention with reference to the attached drawings. In FIGS. 1 through 3, an objective lens 1 is disposed on a lens holder 2, and is fixed by an adhesive 3. The objective lens 1 condenses a laser beam for writing data in an optical disk (not shown) or reading data from the optical disk, onto the optical disk. The objective lens 1 includes an upper spherical surface 1a forming an upper surface of a lens, a lower spherical surface 1b forming a lower surface of the lens, and a periphery portion 1c having a flange shape and forming a circumference portion of the lens. The upper spherical surface 1a and the lower spherical surface 1b are formed as convex shapes having a spherical or an aspherical surface. The periphery portion 1c includes a lower surface 1d forming a ring-shaped plane, and a peripheral side surface portion 1e adjacent to the lower surface portion 1d.

The lens holder 2 includes a lens insertion hole 2a for inserting the lower spherical surface 1b of the objective lens 1, a receiving surface portion 2b formed around the lens insertion hole 2a, and four protrusions 2c formed on the receiving surface portion 2b. A diameter of the lens insertion hole 2a may be less than that of the periphery portion 1c, and greater than that of the lower spherical surface 1b. The receiving surface portion 2b is a plane for defining a position of the optical axis direction of the objective lens. The receiving surface portion 2b widens outward from a portion thereof that contacts the lower surface portion 1d, to have a predetermined area.

The four protrusions 2c have substantially the same height as that of the periphery portion 1c. The center of the four protrusions 2c coincides with a central axis of the lens insertion hole 2a. The four protrusions 2c are arranged at substantially regular intervals along the peripheral side surface portion 1e of the objective lens 1 in the circumferential direction of the lens. Since the peripheral side surface portion 1e contacts inner walls of the protrusions 2c, the position of the objective lens 1 on the lens holder 2 is determined to be in a direction perpendicular to the optical axis direction.

In a state where the objective lens is held on the lens holder, the adhesive 3 is applied to span over a part of the peripheral side surface portion 1e that does not face the protrusions 2c and a part of the receiving surface portion 2b that does not contact the lower surface portion of a periphery portion of the objective lens, thus the objective lens 1 is fixed on the lens holder 2 by the adhesive. Preferably, the adhesive 3 may be applied on between the peripheral side surface portion 1e and the receiving surface portion 2b that does not contact the lower surface portion of a periphery portion of the objective lens, at substantially middle portions between every two neighboring protrusions 2c. The adhesive 3 is not applied on gaps between the peripheral side surface portion 1e and the protrusions 2c, and thus the adhesive 3 does not exist on the gaps.

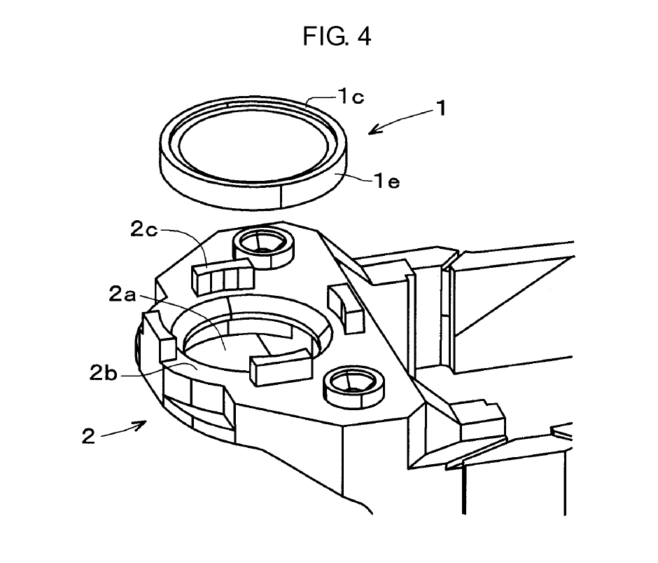

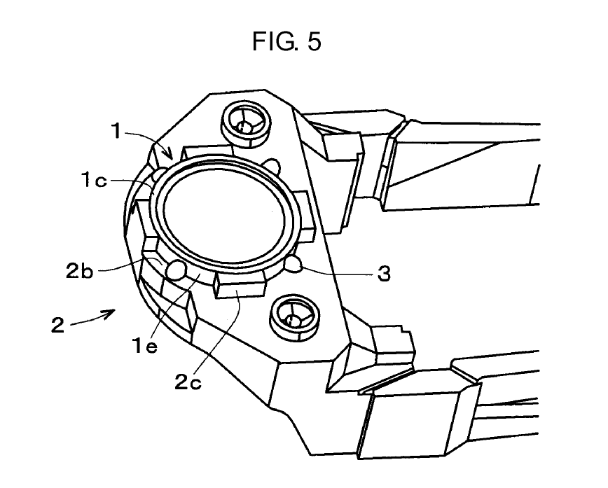

Processes of fabricating the optical pickup device according to the present embodiment will be described with reference to FIGS. 4 and 5. As shown in FIG. 4, the objective lens 1 is arranged over the lens holder 2 so as to descend toward the lens holder 2. Here, the lower spherical surface 1b of the objective lens 1 is inserted into the lens insertion hole 2a so as to make the objective lens 1 concentric with the lens insertion hole 2a. Accordingly, the peripheral side surface portion 1e of the objective lens 1 is descended along the inner walls of the protrusions 2c to contact the lower surface portion 1d of the objective lens 1 with the receiving surface portion 2b of the lens holder 2. Then, the position of the objective lens 1 in a vertical direction (the optical axis direction) is determined, and the position of the objective lens 1 in a surface direction of the receiving surface portion 2b (the direction perpendicular to the optical axis direction) is also determined by the protrusions 2c.

As shown in FIG. 5, the four protrusions 2c of the lens holder 2 contact the peripheral side surface portion 1e of the objective lens 1. The peripheral side surface portion 1e, on which no protrusions 2c are formed, do not contact anything. On the portions where the protrusions 2c do not exist, in a state where the objective lens is held on the lens holder, the adhesive 3 is applied to span over a part of the peripheral side surface portion 1e and the receiving surface portion 2b that does not contact the lower surface portion of a periphery portion of the objective lens, thus the objective lens 1 is fixed on the lens holder 2 by the adhesive. The adhesive 3 is applied in this way so as not to spread over the protrusions 2c and so as not to enter the gaps between the peripheral side surface portion 1e and the protrusions 2c.

In order not to spread the adhesive 3 toward the protrusions 2c, for example, a UV curing adhesive that is thixotrophic and has a viscosity of about 10 Pa·s (pascal·second) may be used as the adhesive 3, and the adhesive 3 is cured by UV rays after being applied. Accordingly, the adhesive 3 may be rapidly cured without spreading to the protrusions 2c, and thus, infiltration of the adhesive 3 into the gaps between the peripheral side surface portion 1e and the protrusions 2c may be prevented.

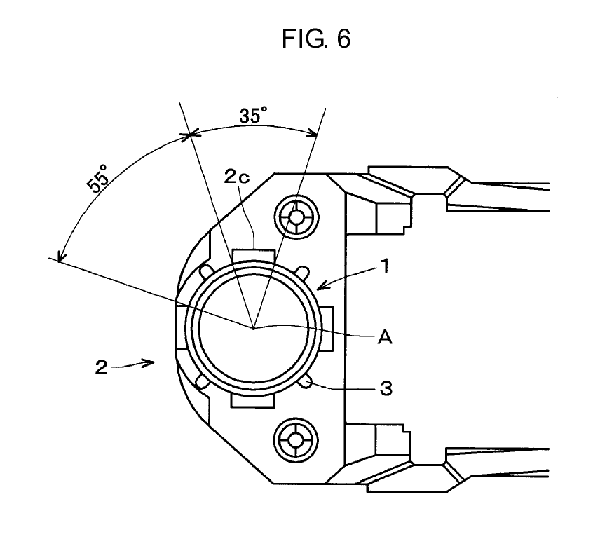

Forming ranges of the protrusions 2c will be described with reference to FIG. 6. As shown in FIG. 6, in the present embodiment, one protrusion 2c exists within an angle of 35° around a central axis A of the lens insertion hole 2a. An angle range, which no protrusion 2c exists, between two neighboring protrusions 2c is 55°. The above angle ranges are examples, and thus, the present invention is not limited thereto. Since the range in which the protrusion 2c is not formed and the adhesive 3 is applied is greater than the range in which the protrusion 2c exists, the applying operation of the adhesive 3 may be performed easily so that the adhesive 3 does not infiltrate into the gaps between the peripheral side surface portion 1e and the protrusions 2c.

The present inventor discovered, through various experiments, that inclination of the objective lens 1 caused by a change in ambient temperature is not only affected by the adhesive moving onto the lower surface portion 1d of the objective lens 1, but also by the adhesive 3 infiltrating into the gaps between the peripheral side surface portion 1e of the objective lens 1 and the surfaces of the lens holder 2 facing the peripheral side surface portion 1e. In more detail, when the adhesive exists between the peripheral side surface portion 1e and the surface of the lens holder 2 facing the peripheral side surface portion 1e, stress is applied from the lens holder 2 to the side surface of the objective lens 1 via the adhesive due to a difference between coefficients of thermal expansion of the objective lens 1, the lens holder 2, and the adhesive. Then, the objective lens 1 is inclined.

As described above, in the present embodiment, the adhesive 3 is not applied on the gaps between the peripheral side surface portion 1e and the protrusions 2c. In addition, since the adhesive 3 is not applied between the lower surface portion 1d and the receiving surface portion 2b intentionally, an amount of the adhesive 3 between the lower surface portion 1d and the receiving surface portion 2b may be ignorable even if the adhesive 3 infiltrates into between the lower surface portion 1d and the receiving surface portion 2b. Therefore, according to the present embodiment, inclination of the objective lens 1 caused by expansion or contraction of the adhesive 3 may be efficiently reduced even when ambient temperature changes.

According to the optical pickup device of the present invention, inclination of the objective lens caused by a change in ambient temperature may be effectively reduced.

While this invention has been particularly shown and described with reference to exemplary embodiments thereof, the present invention is not limited thereto and it will be understood by those skilled in the art that various changes in form and details may be made therein without departing from the spirit and scope of the invention as defined by the appended claims.

What is claimed is:

1. An optical pickup device comprising:
an objective lens; and
a lens holder which holds the objective lens and includes a receiving surface portion that contacts a lower surface portion of a periphery portion of the objective lens, and a plurality of protrusions that protrude from the receiving surface portion to contact a peripheral side surface portion of the objective lens and are separated from each other,
wherein in a state where the objective lens is held on the lens holder, an adhesive is applied to span over a part of the peripheral side surface portion that does not face the protrusions and a part of the receiving surface portion that does not contact the lower surface portion of a periphery portion of the objective lens, thus the objective lens is fixed on the lens holder by the adhesive.

2. The optical pickup device of claim 1, wherein the adhesive is not applied between the peripheral side surface portion of the objective lens and the protrusions.

3. The optical pickup device of claim 1, wherein an angle range of portion in which none of the protrusions are formed is greater than an angle range of portion in which the protrusion is formed, in a circumferential direction of the objective lens on the receiving surface portion.
